(19) United States
(12) Patent Application Publication
(10) Pub. No.: US 2013/0169026 A1
(43) Pub. Date: Jul. 4, 2013

(54) BICYCLE RIM STRUCTURE

(71) Applicant: Mu-Rong LI, Taichung City (TW)

(72) Inventor: Mu-Rong LI, Taichung City (TW)

(21) Appl. No.: 13/342,982

(22) Filed: Jan. 4, 2012

(51) Int. Cl. B60B 1/02

(52) U.S. Cl. 301/58

(57) ABSTRACT

A bicycle rim structure comprises a rim body, a hub, a plurality of spokes for fastening the hub and the rim body, and a plurality of adhesives. The spokes in assembling slots of the rim body and assembling grooves of the hub are enclosed by the adhesive. Therefore, the spoke is tightly connected in the assembling slot and assembling groove after the adhesive is solidified. Moreover, the weight of the bicycle rim body is reduced because there are no bolts and nuts, or other assemblies in the bicycle rim structure.

### BACKGROUND OF THE INVENTION

1. Field of the Invention

The present invention relates to a bicycle rim and more particularly to a bicycle rim structure, in which the spokes of the bicycle rim are assembled between the rim and hub by an adhesive.

2. Description of Related Art

Bicycle activity is more and more popular in the 21st century because bicycle activity is eco-friendly, convenient and entertaining. Many enterprises encourage their employees to go to work by bicycles instead of driving vehicles today. Many people also go shopping or go traveling by bicycles during their leisure time. Therefore, how to reduce the weight of bicycles for people carrying becomes an important topic when bicycle manufacturers design and produce bicycles.

Generally, a conventional bicycle rim comprises an outer circular frame, an inner circular frame and a plurality of spokes which is extended from a hub. The outer circular frame has a plurality of assembling holes defined thereon. The top portion of the assembling hole has a diameter which is larger than a diameter of the bottom portion of the assembling hole, so that the cross-sectional of the assembling hole is a step shape. A plurality of lock units for fastening the spokes on the circular frames are defined in the inner and outer circular frames. The lock unit further comprises a connecting member and a fastener. The connecting member is embedded into the assembling hole. A connecting hole is defined at the center of the connecting member. The bottom of the connecting hole is a curved surface. The fastener is set in the connecting hole of the connecting member. One end of the fastener is enlarged and engaged with the curved surface of the connecting hole tightly. Another end of the fastener is exposed out of the connecting member for screwing the spokes. A tire is surrounding the outer circular frame. The spokes connect the bicycle rim and hub, such that the bicycle rim is rotating with the rotation of the hub.

However, in order to receiving the connecting members, the thickness of the outer circular frame must be increased and the weight of the bicycle rim is increasing, too. In addition, the diameter and the depth of the assembling hole cannot be too large or too small; otherwise the spokes cannot tightly connect to the bicycle rim or the spokes might be inserting into the inner tire when the bicycle is going on the rugged road. How to reduce the weight of the bicycle rim and how to provide a safe connection between the spokes and the bicycle rim becomes an important issue in this field.

The present invention has arisen to mitigate and/or obviate the disadvantages of the conventional.

### SUMMARY OF THE INVENTION

The main objective of the present invention is to provide an improved bicycle rim structure.

To achieve the objective, a bicycle rim structure comprises a rim body, a plurality of assembling slots equidistantly formed along an inner circular frame of the rim body, a hub, one end of the hub being a first hub flange and another end being a second hub flange, a plurality of assembling grooves equidistantly formed around the first hub flange and the second hub flange, a plurality of spokes, one end of the spoke assembled into the assembling slot and another end of the spoke assembled into the assembling groove, a plurality of adhesives; wherein the adhesive is poured into the assembling slot with a constant depth and poured into the assembling groove with another constant depth, such that the spokes in the assembling slots and assembling grooves are enclosed by the adhesive; thereby the spoke is tightly connected in the assembling slot and assembling groove after the adhesive is solidified; the weight of the bicycle rim body is reduced because there are no bolts and nuts or other assemblies in the bicycle rim structure.

Each of the spokes is a flat bar. The rim body is made from carbon fibers. The adhesive is resins, glue or other sticky materials.

A plurality of assembling parts is equidistantly formed along an inner circular frame of the rim body. Each of the assembling parts has one assembling slot defined therein. The assembling part is extending from the inner circular frame to the hub.

One spoke is connected between the assembling slot and the assembling groove formed on the first hub flange; the next spoke is connected between the assembling slot and the assembling groove formed on the second hub flange.

The assembling grooves are radially arranged on the lateral of the first hub flange. The assembling grooves are radially arranged on the lateral of the second hub flange.

Further benefits and advantages of the present invention will become apparent after a careful reading of the detailed description with appropriate reference to the accompanying drawings.

### BRIEF DESCRIPTION OF THE DRAWINGS

FIG. 1 is a cross-sectional view of a bicycle rim structure for showing two spokes which are assembling between a hub and a rim body;

FIG. 1A is a partially enlarged view of the bicycle rim structure for showing the two spokes which are assembling to the hub;

FIG. 1B is a partially enlarged view of the bicycle rim structure for showing the spoke which is assembling to the rim body;

FIG. 2 is a cross-sectional view of a bicycle rim structure of the present invention;

FIG. 2A is a partially enlarged view of the bicycle rim structure for showing the two spokes which are tightly connected to the hub;

FIG. 2B is a partially enlarged view of the bicycle rim structure for showing the two spokes which are tightly connected to the rim body; and

FIG. 3 is a perspective view of the bicycle rim structure of the present invention.

### DETAILED DESCRIPTION OF THE INVENTION

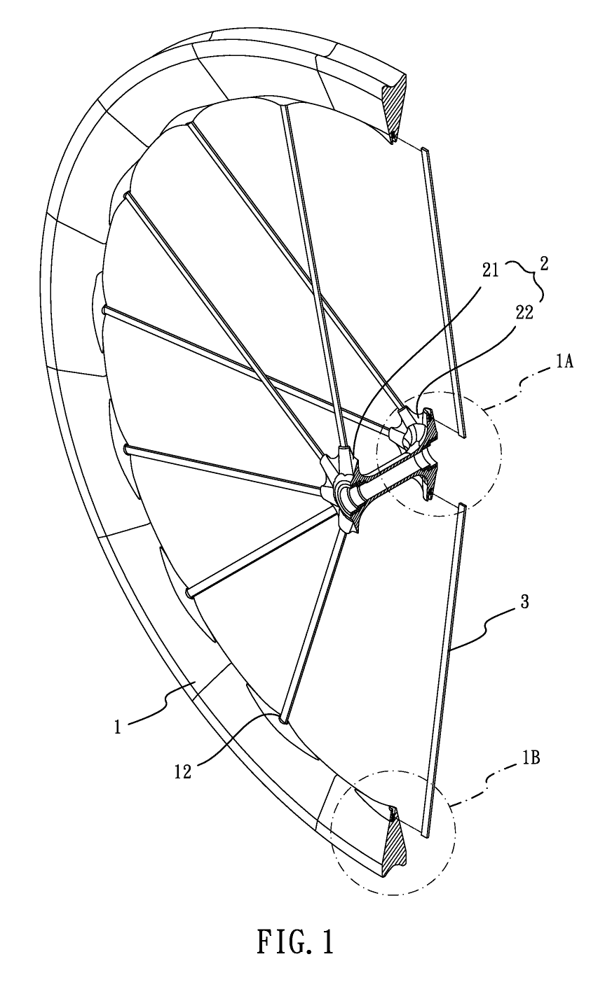

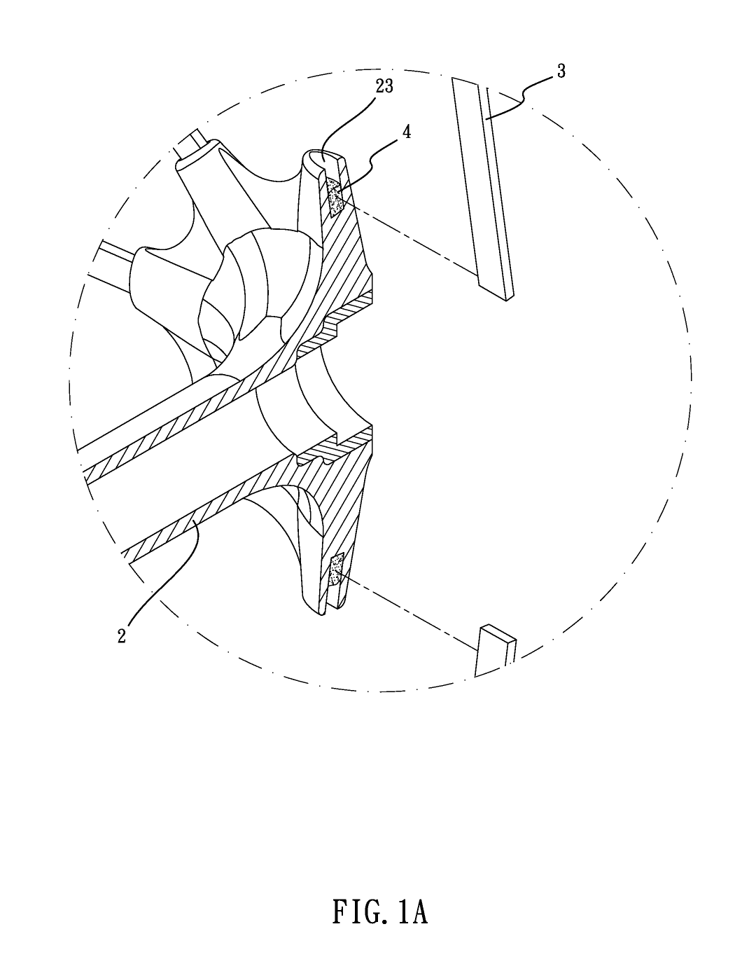

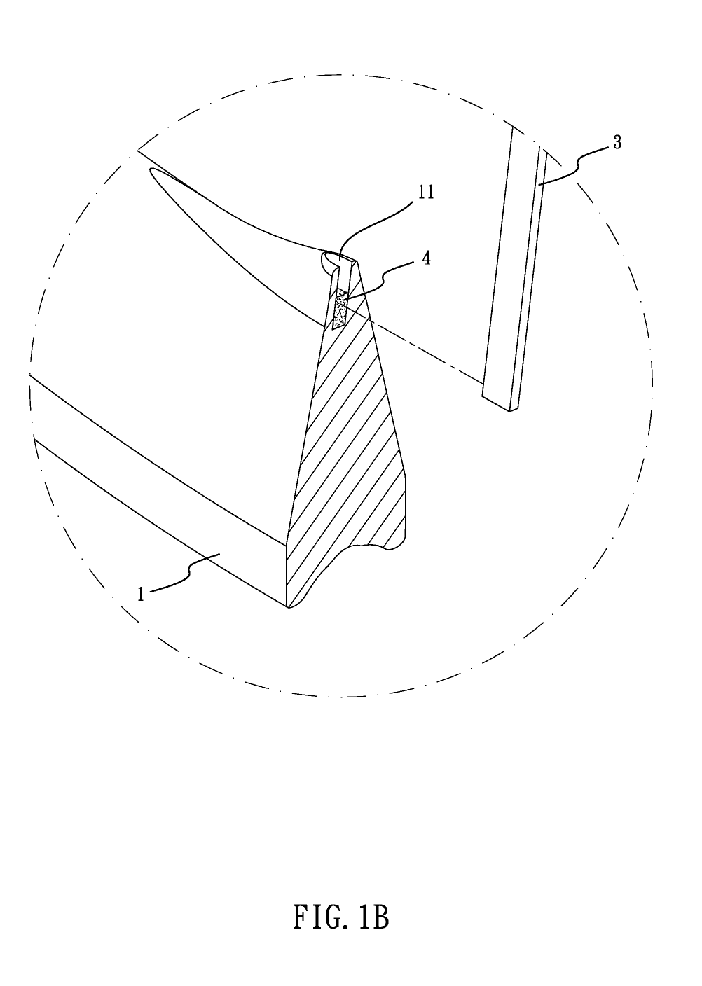

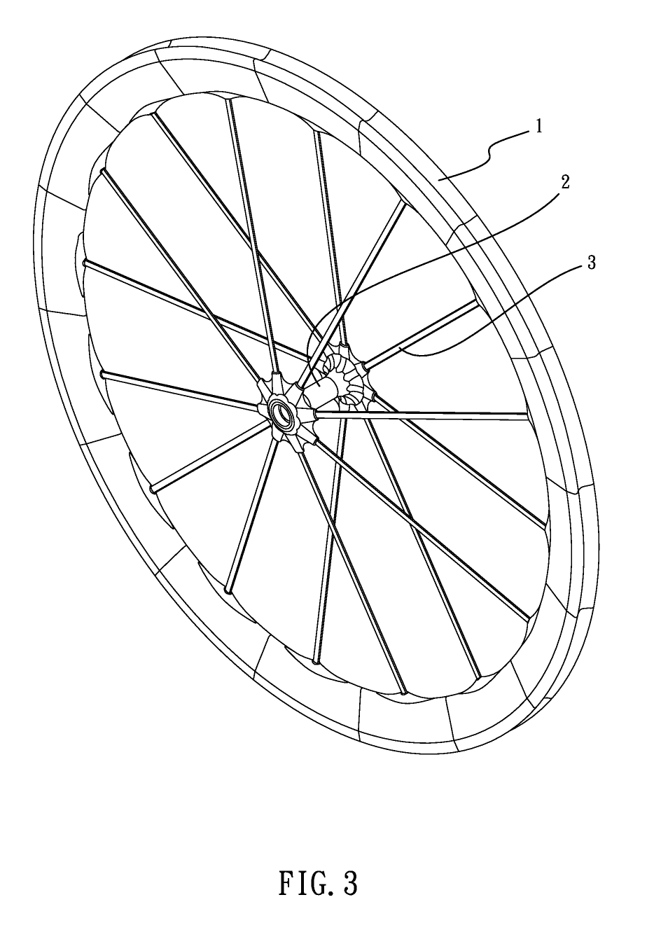

Referring to FIGS. 1-3, a bicycle rim structure comprises a rim body 1, a hub 2, a plurality of spokes 3 for fastening the hub 2 and the rim body 1, and a plurality of adhesives 4.

The rim body 1 is made from carbon fibers. A plurality of assembling parts 12 is equidistantly formed along an inner circular frame of the rim body 1. Each of the assembling parts 12 has an assembling slot 11 defined therein. The assembling part 12 is extending from the inner circular frame to the hub 2, such that the assembling slot 11 is completely receiving one end of the spoke 3. The rim body 1 is stably rotated by the spokes 3 because a contact area between the slot 11 and the spoke 3 is large enough for connection.

One end of the hub 2 is a first hub flange 21 and another end is a second hub flange 22. A plurality of assembling grooves 23 is equidistantly formed around the first hub flange 21 and the second hub flange 22. The assembling grooves 23 are radially arranged on the lateral of the first hub flange 21. The assembling grooves 23 are radially arranged on the lateral of the second hub flange 22.

One end of the spoke 3 is assembled into the assembling slot 11 and another end of the spoke 3 is assembled into the assembling groove 23. Each two neighbor spokes 3 are crossing. One spoke 3 is connected between the assembling slot 11 and the assembling groove 23 formed on the first hub flange 21. The next spoke 3 is connected between the assembling slot 11 and the assembling groove 23 formed on the second hub flange 22. Each of the spokes 3 is a flat bar.

The adhesive 4 is resins, glue or other sticky materials. The adhesive 4 is poured into the assembling slot 11 and the assembling groove 23 for sticking the spoke 3 to the assembling slot 11 and to the assembling groove 23.

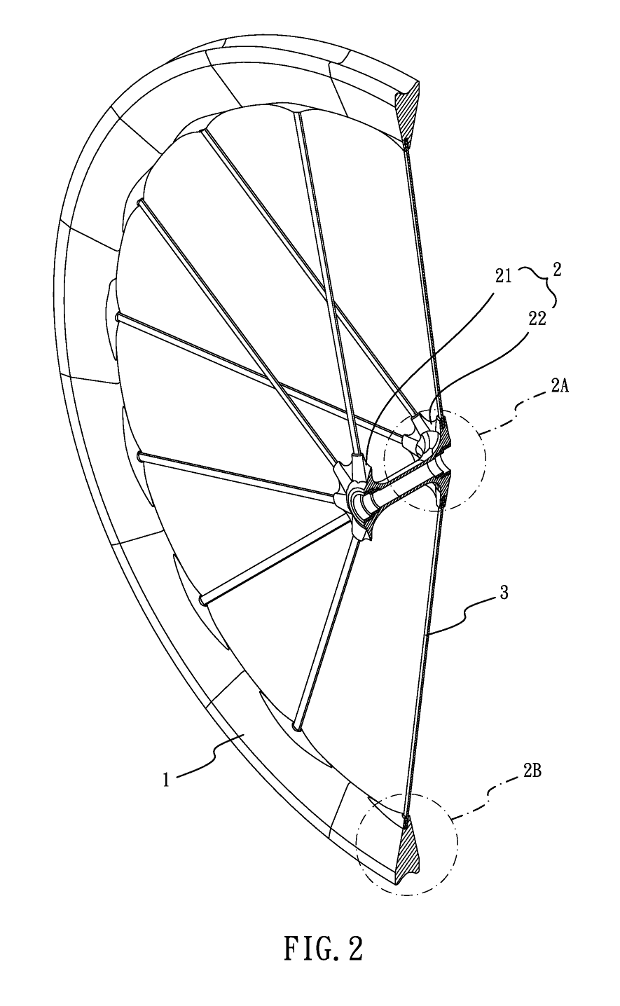

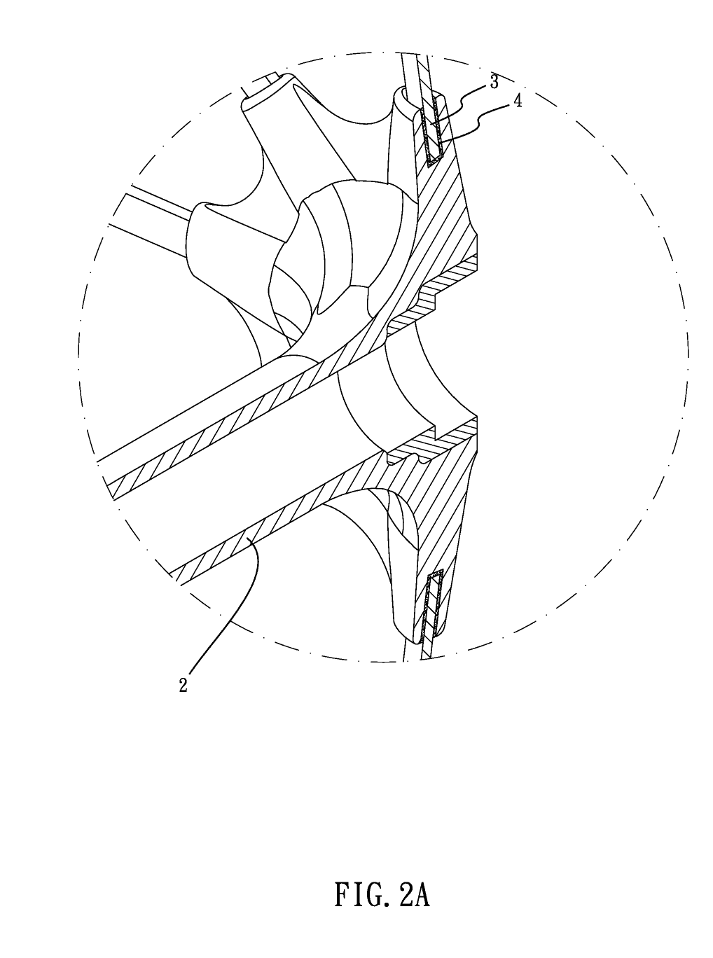

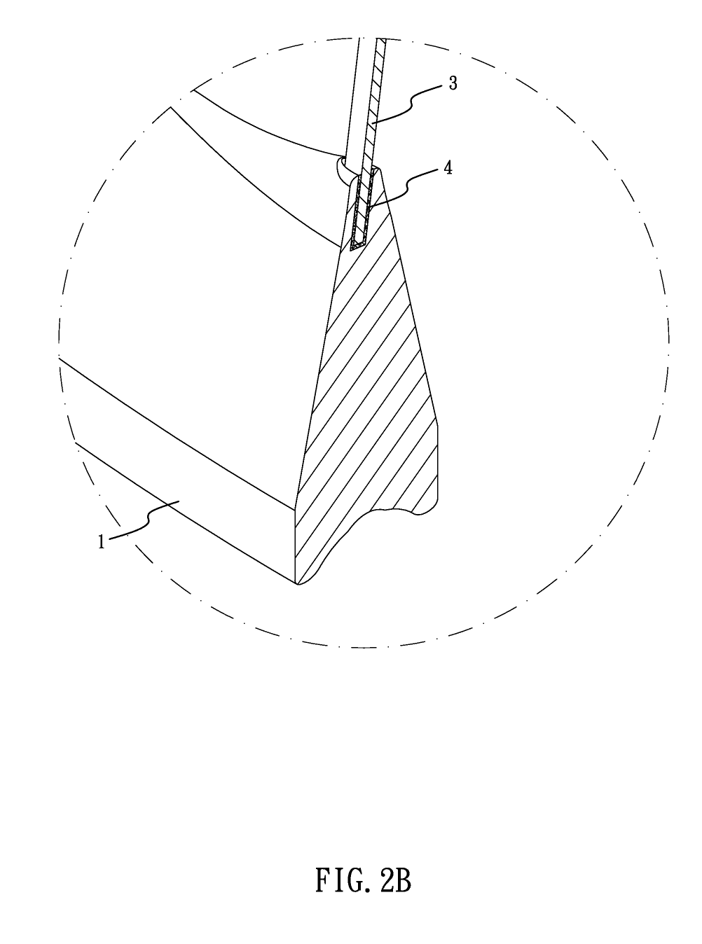

Referring to FIGS. 1A and 2A, the adhesive 4 is poured into the assembling groove 23 of the hub 2 with a constant depth, such that the assembling groove 23 is filled with adhesive 4 when the spoke 3 is inserted into the assembling groove 23. The spoke 3 in the assembling groove 23 is enclosed by the adhesive 4. After the adhesive 4 is solidified, the spoke 3 is tightly connected in the assembling groove 23.

Referring to FIGS. 1B and 2B, the adhesive 4 is poured into the assembling slot 11 of the rim body 1 with a constant depth, such that the assembling slot 11 is filled with adhesive 4 when the spoke 3 is inserted into the assembling slot 11. The spoke 3 in the assembling slot 11 is enclosed by the adhesive 4. After the adhesive 4 is solidified, the spoke 3 is tightly connected in the assembling slot 11.

All in all, the spokes 3 are connected between the hub 2 and the rim body 1 by the adhesive 4, so that those heavy bolts or nuts are not necessary in the bicycle rim structure. In other words, the weight of the bicycle rim structure is reduced dramatically. Moreover, the solidified adhesive 4 plays as a buffer for stopping the spokes 3 to insert into a tire.

Although the invention has been explained in relation to its preferred embodiment, it is to be understood that many other possible modifications and variations can be made without departing from the spirit and scope of the invention as hereinafter claimed.

What is claimed is:

1. A bicycle rim structure comprising:
a rim body, a plurality of assembling slots equidistantly formed along an inner circular frame of the rim body;
a hub, one end of the hub being a first hub flange and another end being a second hub flange, a plurality of assembling grooves equidistantly formed around the first hub flange and the second hub flange;
a plurality of spokes, one end of the spoke assembled into the assembling slot and another end of the spoke assembled into the assembling groove; and
a plurality of adhesives; wherein the adhesive is poured into the assembling slot with a constant depth and poured into the assembling groove with another constant depth, such that the spokes in the assembling slots and assembling grooves are enclosed by the adhesive;
thereby the spoke is tightly connected in the assembling slot and assembling groove after the adhesive is solidified; the weight of the bicycle rim body is reduced because there are no bolts and nuts or other assemblies in the bicycle rim structure.

2. The bicycle rim structure as claimed in claim 1, wherein each of the spokes is a flat bar.

3. The bicycle rim structure as claimed in claim 1, wherein the rim body is made from carbon fibers.

4. The bicycle rim structure as claimed in claim 1, wherein the adhesive is resins, glue or other sticky materials.

5. The bicycle rim structure as claimed in claim 1, wherein a plurality of assembling parts is equidistantly formed along an inner circular frame of the rim body, each of the assembling parts having one assembling slot defined therein, the assembling part extending from the inner circular frame to the hub.

6. The bicycle rim structure as claimed in claim 1, wherein one spoke is connected between the assembling slot and the assembling groove formed on the first hub flange; the next spoke is connected between the assembling slot and the assembling groove formed on the second hub flange.

7. The bicycle rim structure as claimed in claim 1, wherein the assembling grooves are radially arranged on the lateral of the first hub flange.

8. The bicycle rim structure as claimed in claim 1, wherein the assembling grooves are radially arranged on the lateral of the second hub flange.
